(19) United States
(12) Patent Application Publication
(10) Pub. No.: US 2026/0155569 A1
(43) Pub. Date: Jun. 4, 2026

(54) ANTENNA AND COMMUNICATION DEVICE

(71) Applicant: Huawei Technologies Co., Ltd., Shenzhen (CN)

(72) Inventors: Chengdai Xue, Dongguan (CN); Ming Zhou, Dongguan (CN); Jicheng Fu, Shenzhen (CN); Jiongsai Zhou, Shenzhen (CN); Chao Ren, Dongguan (CN)

(21) Appl. No.: 19/465,229

(22) Filed: Jan. 30, 2026

Related U.S. Application Data
(63) Continuation of application No. PCT/CN2024/099049, filed on Jun. 13, 2024.

(30) Foreign Application Priority Data
Jul. 31, 2023 (CN) 202310957575.1

(51) Int. Cl. H01Q 9/04; H01Q 21/26

(52) U.S. Cl. CPC H01Q 9/04; H01Q 21/26

(57) ABSTRACT

This application provides an antenna and a communication device, and relates to the field of communication technologies. The antenna provided in this application includes a radiation assembly, a coupling structure, and a balun structure. The coupling structure is disposed so that a feeding connection can be implemented between the balun structure and a first radiator in the radiation assembly.

### CROSS-REFERENCE TO RELATED APPLICATIONS

This application is a continuation of International Application No. PCT/CN2024/099049, filed on Jun. 13, 2024, which claims priority to Chinese Patent Application No. 202310957575.1, filed on Jul. 31, 2023. The disclosures of the aforementioned applications are hereby incorporated by reference in their entireties.

### TECHNICAL FIELD

This application relates to the field of communication technologies, and in particular, to an antenna and a communication device.

### BACKGROUND

With rapid development of wireless communication technologies, a requirement for a capacity of an antenna system in the industry is also increasing. To increase a data transmission rate and a channel capacity of the antenna system, a multiple-input multiple-output (MIMO) technology is developed. Briefly, MIMO means that a plurality of radiators are used at both a transmitting end and a receiving end, so that a plurality of channels are formed between the transmitting end and the receiving end. However, as a quantity of radiators increases, manufacturing costs of an antenna is also significantly increased. For example, all current radiators are manufactured by using sheet metal. In addition, to ensure performance of the antenna, the radiators are all electrically connected to a feed network in a direct feeding manner. To ensure effect of an electrical connection between the radiator and the feed network, electroplating processing is usually performed on a surface of the radiator, to improve conductivity of the radiator. However, electroplating processing increases manufacturing costs of the antenna, and is not conducive to energy saving and emission reduction. Therefore, how to reduce manufacturing costs while ensuring performance of the antenna becomes a technical problem to be urgently resolved.

### SUMMARY

This application provides an antenna that has a simple structure, is easy to manufacture, and has good signal transmission performance, and a communication device.

According to a first aspect, this application provides an antenna, including a radiation assembly, a coupling structure, and a balun structure. The radiation assembly includes a plurality of first radiators, and each first radiator has a feeding part. The coupling structure has a plurality of coupling parts, and the plurality of coupling parts are coupled to the plurality of feeding parts in one-to-one correspondence. The balun structure has a plurality of feed lines, and the plurality of feed lines are connected to the plurality of coupling parts in one-to-one correspondence. In the coupling part and the feeding part that are correspondingly coupled, there is a spacing between the coupling part and the feeding part, an area of overlapping between the coupling part and the feeding part is greater than or equal to 0.025λ*0.025λ, and the spacing between the coupling part and the feeding part is less than or equal to 1 mm. λ is a wavelength of an electromagnetic wave of a lowest operating frequency of the first radiator when the electromagnetic wave is propagated in space. In the antenna provided in this embodiment of this application, the coupling structure is disposed, so that a feeding connection between the balun structure and the first radiator in the radiation assembly can be implemented. In other words, the coupling structure is conductively connected to the balun structure, and the coupling structure is coupled to the first radiator to implement a feeding connection. When the coupling structure and the first radiator are disposed in a coupled feeding manner, a requirement for conductivity of a surface of the first radiator is low, thereby helping reduce material use costs and manufacturing costs of the first radiator. In addition, when the area of overlapping between the coupling part and the feeding part is greater than or equal to 0.025λ*0.025λ, and the spacing between the coupling part and the feeding part is less than or equal to 1 mm, effect of coupling between the first radiator and the coupling structure can be effectively ensured, thereby ensuring performance of the antenna.

In an example, the coupling structure may include a first substrate, and the first substrate has a first plate surface and a second plate surface that are disposed opposite to each other. The first plate surface has a plurality of conductive plates, and each conductive plate forms the coupling part. During manufacturing, the coupling structure may be manufactured by using a process of manufacturing a printed circuit board, a flexible circuit board, or the like, and has advantages such as ease of manufacturing and low costs.

During specific disposition, the second plate surface is attached to the feeding part, and a thickness of the first substrate is less than or equal to 1 mm. Between the coupling part and the feeding part that are correspondingly coupled, the spacing between the coupling part and the feeding part may be effectively controlled by using the thickness of the first substrate.

In an example, the antenna may further include an insulating spacer, and a thickness of the insulating spacer is less than or equal to 1 mm; and the first plate surface is disposed facing the feeding part, and the insulating spacer is attached between the feeding part and the coupling part. Between the coupling part and the feeding part that are correspondingly coupled, the spacing between the coupling part and the feeding part may be effectively controlled by using the thickness of the insulating spacer.

During specific disposition, the plurality of first radiators include a first polarization radiator and a second polarization radiator that are adjacently disposed. The first polarization radiator has a coupling stub extending along an edge of the second polarization radiator, a spacing between the coupling stub and the second polarization radiator is less than or equal to 2 mm, and a length of the coupling stub is greater than or equal to 0.02λ and less than or equal to 0.1λ. λ is the wavelength of the electromagnetic wave of the lowest operating frequency of the radiator when the electromagnetic wave is propagated in space. The coupling stub is disposed, so that isolation between the first polarization radiator and the second polarization radiator can be effectively improved, thereby reducing signal interference between the first polarization radiator and the second polarization radiator.

In an example, the balun structure may include a second substrate, and the second substrate has a third plate surface and a fourth plate surface that are opposite to each other. The feeding structure may include a first polarization feed line, a second polarization feed line, a first polarization ground plate, and a second polarization ground plate. The first polarization feed line and the second polarization feed line may be disposed on the third plate surface, and the first polarization feed line and the second polarization feed line may be parallel to each other. The first polarization ground plate and the second polarization ground plate may be disposed on the fourth plate surface, and there is a spacing between the first polarization ground plate and the second polarization ground plate. A length of the spacing is greater than or equal to 0.125λ and less than or equal to 0.25λ, a width of the spacing is greater than or equal to 0.01λ and less than or equal to 0.1λ, and λ is the wavelength of the electromagnetic wave of the lowest operating frequency of the first radiator when the electromagnetic wave is propagated in space. The coupling structure may have four coupling parts, and one end of the first polarization feed line, one end of the second polarization feed line, one end of the first polarization ground plate, and one end of the second polarization ground plate are respectively connected to the four coupling parts, to implement a feeding connection between the coupling structure and the balun structure. The balun structure is a single-layer plate structure and has an advantage of flattening, so that manufacturing convenience and application flexibility of the balun structure can be effectively improved.

In an example, the antenna may further include a second radiator, the first radiator is located in a radiation direction of the second radiator, and an operating frequency band of the second radiator is greater than an operating frequency band of the first radiator. The first radiator and the second radiator operate on different frequency bands, so that performance such as a bandwidth of the antenna can be effectively extended.

During specific disposition, the first radiator may include a base frame and a first open-circuit stub, the first open-circuit stub has a first end and a second end, the first end is connected to the base frame, the second end extends to the inside of the base frame, and the first open-circuit stub has a gradient structure between the first end and the second end. The first open-circuit stub is disposed, so that decoupling between the first radiator and the second radiator can be effectively implemented, to avoid an adverse situation such as interference between the first radiator and the second radiator, thereby ensuring operating performance of the antenna.

During specific disposition, a shape of the gradient structure may be any one of a triangle, a diamond, an ellipse, or a semi-ellipse.

In an example, the first radiator may further include a second open-circuit stub, a length of the second open-circuit stub is ⅛λ′, and λ′ is a wavelength corresponding to a center frequency of the second radiator.

During specific disposition, the first radiator may include a plurality of second open-circuit stubs, and a distance between two adjacent second open-circuit stubs is less than or equal to 0.2λ′.

The second open-circuit stub is straight-line-shaped, broken-line-shaped, cross-shaped, or the like. During actual application, a size, a shape, and a position layout of the second open-circuit stub can be properly set according to an actual requirement.

According to a second aspect, this application further provides a communication device, including a radio frequency processing unit and the foregoing antenna. The antenna has a feed network, and the radio frequency processing unit is connected to the feed network. The feed network is configured to send a feeding signal to the radiation assembly, or a radio signal received by the radiation assembly may be transmitted to the feed network by using the coupling structure and the balun structure. The radio frequency processing unit may be configured to perform frequency selection, amplification, and down-conversion processing on a signal received by the antenna. In the communication device provided in this application, by using the foregoing antenna, manufacturing costs and material use costs can be effectively reduced, and signal transmission performance is good.

### BRIEF DESCRIPTION OF THE DRAWINGS

FIG. 1 is a diagram of an application scenario of an antenna according to an embodiment of this application;

FIG. 2 is a diagram of a structure of a base station according to an embodiment of this application;

FIG. 3 is a block diagram of a structure of an antenna according to an embodiment of this application;

FIG. 4 is a diagram of a three-dimensional structure of an antenna according to an embodiment of this application;

FIG. 5 is a diagram of an exploded structure of an antenna according to an embodiment of this application;

FIG. 6 is a diagram of a partial cross-sectional structure of an antenna according to an embodiment of this application;

FIG. 7 is a diagram of a planar structure of a first radiator according to an embodiment of this application;

FIG. 8 is a diagram of a planar structure of a radiation assembly according to an embodiment of this application;

FIG. 9 is a diagram of a planar structure of an antenna according to an embodiment of this application;

FIG. 10 is a diagram of a partial cross-sectional structure of an antenna according to an embodiment of this application;

FIG. 11 is a diagram of a planar structure of another radiation assembly according to an embodiment of this application;

FIG. 12 is a diagram of a planar structure of another radiation assembly according to an embodiment of this application;

FIG. 13 is a diagram of a planar structure of another radiation assembly according to an embodiment of this application;

FIG. 14 is a diagram of a partial cross-sectional structure of another antenna according to an embodiment of this application;

FIG. 15 is a diagram of a partial cross-sectional structure of another antenna according to an embodiment of this application;

FIG. 16 is a diagram of a partial cross-sectional structure of another antenna according to an embodiment of this application;

FIG. 17 is a diagram of a three-dimensional structure of a balun structure according to an embodiment of this application;

FIG. 18 is a diagram of a three-dimensional structure of a balun structure from another perspective according to an embodiment of this application;

FIG. 19 is a diagram of a three-dimensional structure of an antenna according to an embodiment of this application;

FIG. 20 is a diagram of a cross-sectional structure of an antenna according to an embodiment of this application;

FIG. 21 is a diagram of a planar structure of a first radiator according to an embodiment of this application;

FIG. 22 is a data simulation diagram of a standing wave ratio of an antenna according to an embodiment of this application;

FIG. 23 is a data simulation diagram of isolation of an antenna according to an embodiment of this application; and

FIG. 24 is a diagram of a structure of a communication device according to an embodiment of this application.

### DETAILED DESCRIPTION OF ILLUSTRATIVE EMBODIMENTS

To make the objectives, technical solutions, and advantages of this application clearer, the following further describes this application in detail with reference to the accompanying drawings.

An antenna provided in embodiments of this application may be used in a communication device such as a base station or radar, to implement a wireless communication function.

As shown in FIG. 1, the application scenario may include a base station and a terminal. Wireless communication may be implemented between the base station and the terminal. The base station may be located in a base station subsystem (BBS), a terrestrial radio access network (UTRAN), or an evolved terrestrial radio access network (E-UTRAN), and is configured to perform cell coverage of a radio signal, to implement communication between a terminal device and a wireless network. Specifically, the base station may be a base transceiver station (BTS) in a global system for mobile communications (GSM) or a code division multiple access (CDMA) system, or may be a NodeB (NB) in a wideband code division multiple access (WCDMA) system, or may be an evolved NodeB (eNB or eNodeB) in a long term evolution (LTE) system, or may be a radio controller in a cloud radio access network (CRAN) scenario. Alternatively, the base station may be a relay station, an access point, a vehicle-mounted device, a wearable device, a gNodeB (gNodeB or gNB) in a new radio (NR) system, a base station in a future evolved network, or the like. This is not limited in embodiments of this application.

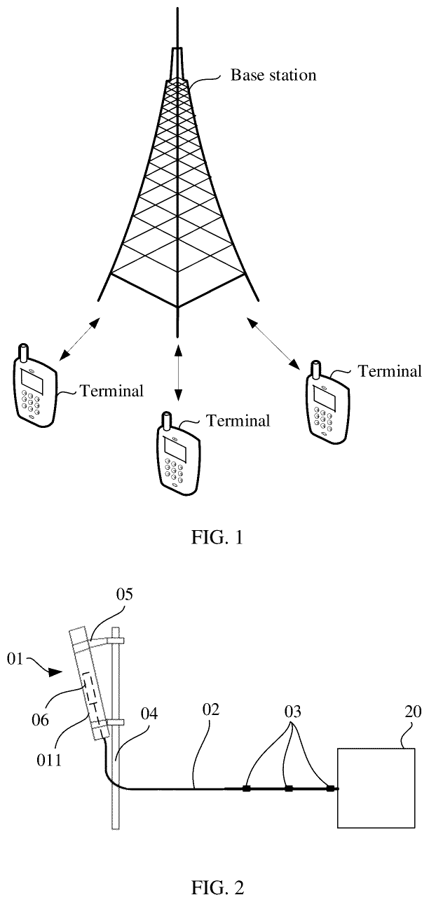

As shown in FIG. 2, a base station provided in embodiments of this application includes a base station antenna feeder system. During actual application, the base station antenna feeder system mainly includes an antenna 01, a feed line 02, a grounding apparatus 03, and the like. The antenna 01 is generally fastened to a pole 04, and a downtilt of the antenna 01 may be adjusted through an antenna adjustment mounting bracket 05, to adjust a signal coverage area of the antenna 01 to some extent.

In addition, the base station may further include a radio frequency processing unit 06 and a baseband processing unit 20. For example, the radio frequency processing unit 06 may be configured to: perform frequency selection, amplification, and down-conversion processing on a signal received by the antenna 01, convert the signal into an intermediate frequency signal or a baseband signal, and send the intermediate frequency signal or the baseband signal to the baseband processing unit 20. Alternatively, the radio frequency processing unit 06 is configured to: perform up-conversion and amplification processing on an intermediate frequency signal sent by the baseband processing unit 20, convert the intermediate frequency signal into a radio signal through the antenna 01, and send the radio signal. The baseband processing unit 20 may be connected to a feed network of the antenna 01 through the radio frequency processing unit 06. In some implementations, the radio frequency processing unit 06 may also be referred to as a remote radio unit (RRU), and the baseband processing unit 20 may also be referred to as a baseband unit (BBU).

As shown in FIG. 2, in a possible embodiment, the radio frequency processing unit 06 may be integrated with the antenna 01, the baseband processing unit 20 is located at a remote end of the antenna 01, and the radio frequency processing unit 06 may be connected to the baseband processing unit 20 through the feed line 02. In another embodiment, both the radio frequency processing unit 06 and the baseband processing unit 20 may be located at a remote end of the antenna 01.

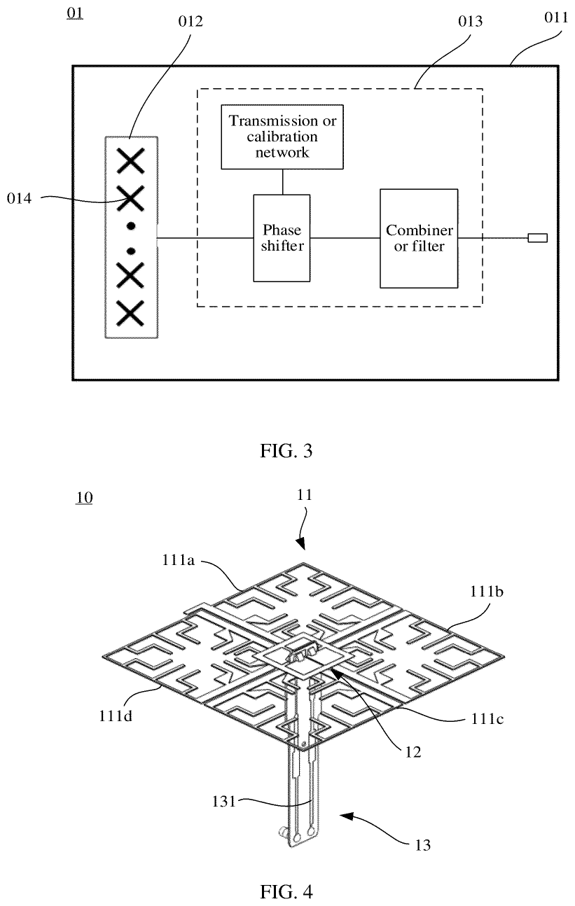

As shown in FIG. 2 and FIG. 3, the antenna 01 used in the base station may further include a radome 011, and a reflection plate 012 and a feed network 013 that are located in the radome 011. The reflection plate 012 may also be referred to as a bottom plate. A main function of the feed network 013 is to feed a signal to a radiation assembly 014 based on a specific amplitude and phase, or send a radio signal received by the radiation assembly 014 to the baseband processing unit 20 of the base station based on a specific amplitude and phase. It may be understood that, during specific implementation, the feed network 013 may include at least one of a phase shifter, a combiner, a transmission or calibration network, a filter, or the like. A component and a type of the feed network 013 and a function that can be implemented by the feed network 013 are not limited in this application.

Certainly, the antenna 01 may also be used in a plurality of other types of communication devices. An application scenario of the antenna 01 is not limited in this application.

For the radome 011, in terms of electrical performance, the radome 011 has good electromagnetic wave penetrability, so that normal sending and receiving of an electromagnetic wave between the radiation assembly 014 and the outside are not affected. In terms of mechanical performance, the radome 011 has good force-bearing performance, anti-oxidation performance, and the like, so that the radome 011 can withstand corrosion of an external harsh environment.

The radiation assembly 014 may include one or more radiators. The radiator may also be referred to as a dipole. The radiator or the dipole is a unit that forms a basic structure of the radiation assembly 014, and can effectively transmit or receive an electromagnetic wave. When the radiation assembly 014 includes a plurality of radiators, the plurality of radiators may form an array for use. During specific application, the radiation assembly may be classified into a single-polarized type, a dual-polarized type, and the like. During specific configuration, a type of the radiation assembly may be properly selected according to an actual requirement.

With continuous development of mobile communication technologies, a 5th generation mobile communication technology (5G) is also widely applied. As one of key technologies of a 5G communication system, a massive multiple-input multiple-output (MIMO) technology can effectively increase a channel capacity. In the background of the massive multiple-input multiple-output technology, a large quantity of radiators need to be arranged in an antenna. As a quantity of radiators increases, manufacturing costs of the antenna is also significantly increased. For example, all current radiators are manufactured by using sheet metal. In addition, to ensure performance of the antenna, the radiators are all electrically connected to a feed network in a direct feeding manner. To ensure effect of an electrical connection between the radiator and the feed network, electroplating processing is usually performed on a surface of the radiator, to improve conductivity of the radiator. However, electroplating processing increases manufacturing costs of the antenna, and is not conducive to energy saving and emission reduction. Therefore, how to reduce manufacturing costs while ensuring performance of the antenna becomes a technical problem to be urgently resolved.

Therefore, embodiments of this application provide an antenna that has a simple structure, is easy to manufacture, and has good signal transmission performance.

To make the objectives, technical solutions, and advantages of this application clearer, the following further describes this application in detail with reference to the accompanying drawings and specific embodiments.

As shown in FIG. 4, in an example provided in this application, an antenna 10 may include a radiation assembly 11, a coupling structure 12, and a balun structure 13. The radiation assembly 11 is configured to transmit or receive an electromagnetic wave. The coupling structure 12 is connected between the radiation assembly 11 and the balun structure 13, to implement a feeding connection between the radiation assembly 11 and the balun structure 13.

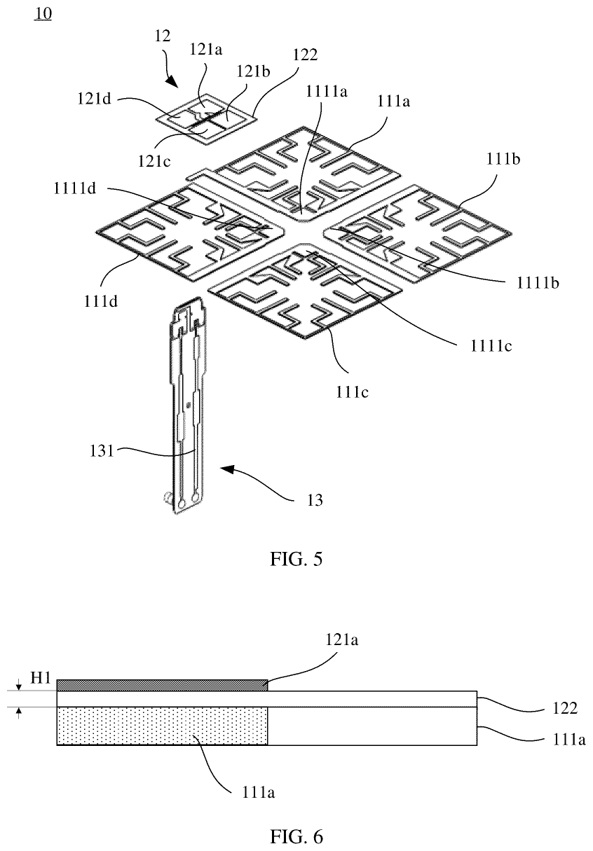

As shown in FIG. 4 and FIG. 5, the radiation assembly 11 includes four first radiators, and each first radiator has a feeding part. Specifically, the four first radiators are respectively a first radiator 111a, a first radiator 111b, a first radiator 111c, and a first radiator 111d. The first radiator 111a has a feeding part 1111a, the first radiator 111b has a feeding part 1111b, the first radiator 111c has a feeding part 1111c, and the first radiator 111d has a feeding part 1111d. The coupling structure 12 has four coupling parts, and the four coupling parts are coupled to the four feeding parts in one-to-one correspondence. The four coupling parts are respectively a coupling part 121a, a coupling part 121b, a coupling part 121c, and a coupling part 121d. The coupling part 121a is coupled to the feeding part 1111a, the coupling part 121b is coupled to the feeding part 1111b, the coupling part 121c is coupled to the feeding part 1111c, and the coupling part 121d is coupled to the feeding part 1111d. In other words, the coupling structure 12 may be separately in a feeding connection to the four radiators in a coupled feeding manner. The balun structure 13 has feed lines 131, and the feed lines 131 are correspondingly connected to a plurality of coupling parts. The coupling structure 12 is disposed between the balun structure 13 and the first radiator, to avoid a feeding connection between the balun structure 13 and the first radiator in a short-circuit connection manner.

It may be understood that, during actual application, the radiation assembly 11 may include two first radiators, three first radiators, or more first radiators, and each first radiator has a feeding part. In addition, the radiation assembly 11 including a plurality of first radiators may be of a single-polarized type, a dual-polarized type, or the like. This is not specifically limited in this application.

In addition, a specific quantity of coupling parts of the coupling structure 12 may be correspondingly set based on a specific quantity of first radiators or feeding parts in the radiation assembly 11, so that each first radiator can be coupled to the coupling structure 12.

In summary, during actual application, the radiation assembly 11 may include a plurality of first radiators, and each first radiator has a feeding part. The coupling structure 12 may have a plurality of coupling parts, and the plurality of coupling parts are coupled to the plurality of feeding parts in one-to-one correspondence.

In the antenna 10 provided in this embodiment of this application, the coupling structure 12 is disposed, so that a feeding connection between the balun structure 13 and the first radiator in the radiation assembly 11 can be implemented. In other words, the coupling structure 12 is conductively connected to the balun structure 13, and the coupling structure 12 is coupled to the first radiator to implement a feeding connection. When the coupling structure 12 and the first radiator are disposed in a coupled feeding manner, a requirement for conductivity of a surface of the first radiator is low, thereby helping reduce material use costs and manufacturing costs of the first radiator.

Alternatively, it may be understood that in some antennas 10, a feeding connection may be implemented between the balun structure 13 and the first radiator in a short-circuit connection manner, to ensure effect of feeding between the balun structure 13 and the first radiator, and ensure operating performance of the antennas 10. However, when the short-circuit connection manner is used, to ensure effect of an electrical connection between the first radiator and the balun structure 13, the first radiator needs to be manufactured by using a material with good conductivity, increasing material use costs. Alternatively, in some implementations, electroplating processing may be performed on the surface of the first radiator, to ensure conductivity of the surface of the first radiator. However, additional electroplating processing significantly increases manufacturing costs of the first radiator.

In addition, in the antenna 10 provided in this application, a relative relationship between the coupling structure 12 and the first radiator for implementing coupled feeding is properly set, so that effect of feeding between the coupling structure 12 and the first radiator can be effectively ensured, and operating performance of the antenna 10 can be ensured.

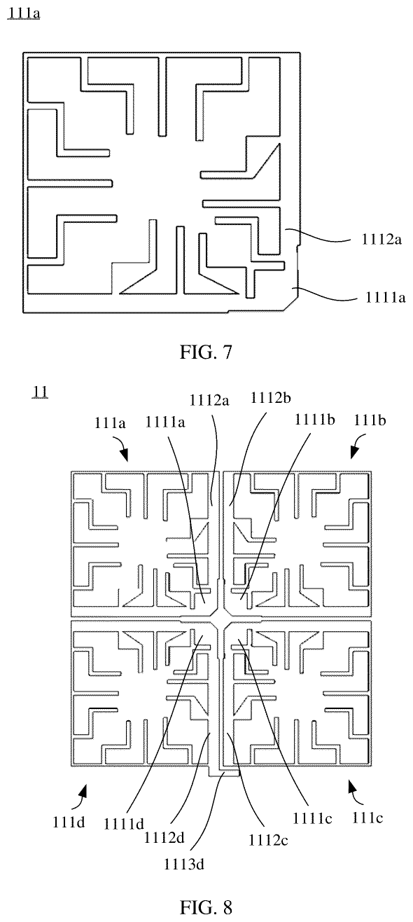

Specifically, as shown in FIG. 6, the coupling part 121a and the feeding part 1111a are used as an example. In the coupling part 121a and the feeding part 1111a that are correspondingly coupled, there is a spacing H1 between the coupling part 121a and the feeding part 1111a, and an area of overlapping between the coupling part 121a and the feeding part 1111a is greater than or equal to 0.025λ*0.025λ. In addition, the spacing H1 between the coupling part 121a and the feeding part 1111a is less than or equal to 1 mm. In other words, it is ensured that there is a proper area of overlapping and a proper spacing H1 between the coupling part 121a and the feeding part 1111a, so that good effect of feeding between the coupling part 121a and the feeding part 1111a can be ensured, and operating performance of the antenna 10 can be ensured. It should be noted that the foregoing merely uses the coupling part 121a and the feeding part 1111a as an example for description. However, for corresponding settings between another coupling part and feeding part that are correspondingly coupled, refer to the corresponding settings between the coupling part 121a and the feeding part 1111a. Details are not described herein again.

It may be understood that, during actual application, operating frequencies of all the first radiators in the radiation assembly 11 are basically the same, and the operating frequency of the first radiator is an interval range. In other words, a frequency of an electromagnetic wave transmitted or received by the first radiator is a frequency band, and λ is a wavelength of an electromagnetic wave of a lowest operating frequency of the first radiator when the electromagnetic wave is propagated in space.

The following describes in detail the antenna 10 in this application with reference to different embodiments.

For ease of understanding of the technical solutions of this application, in the following examples, an example in which the radiation assembly 11 includes four first radiators and the four first radiators form a dual-polarized antenna is used for description.

As shown in FIG. 7, in an example provided in this application, structures of the four first radiators are basically the same. The first radiator 111a is used as an example. The first radiator 111a is a rectangular sheet structure. The first radiator 111a has a rectangular base frame 1112a. There is a rectangular feeding part 1111a at one corner (for example, a lower right corner in FIG. 7) inside the base frame 1112a. The feeding part 1111a can provide a sufficiently large feeding area, to ensure that there is a sufficiently large area of coupling between the feeding part 1111a and the corresponding coupling part, thereby ensuring effect of coupling between the first radiator 111a and the coupling structure 12.

In addition, as shown in FIG. 8, in an example provided in this application, the radiation assembly 11 is of a dual-polarized type. The four first radiators 111 are located in a same approximate plane. The first radiator 111a and the first radiator 111c are diagonally disposed, and the first radiator 111a and the first radiator 111c may be respectively understood as first polarization radiators in a first polarization direction. The first radiator 111b and the first radiator 111d are diagonally disposed, the first radiator 111b and the first radiator 111d may be respectively understood as second polarization radiators in a second polarization direction, and the first polarization direction is perpendicular to the second polarization direction.

In addition, in an example provided in this application, the first radiator 111d has a coupling stub 1113d extending along an edge of the first radiator 111c, a spacing between the coupling stub 1113d and the first radiator 111c is less than or equal to 2 mm, and a length of the coupling stub 1113d is greater than or equal to 0.02λ and less than or equal to 0.1λ. The coupling stub 1113d is disposed, so that isolation between the first radiator 111d and the first radiator 111c can be effectively improved, thereby reducing signal interference between the first radiator 111d and the first radiator 111c. In addition, because the first radiator 111a and the first radiator 111c are in a same polarization direction, and the first radiator 111b and the first radiator 111d are in a same polarization direction, the coupling stub 1113d can also improve isolation between the first radiator 111a and the first radiator 111b. In other words, the coupling stub 1113d can improve isolation between first radiators in different polarization directions.

In another example, the coupling stub 1113d may alternatively be disposed on at least one of the first radiator 111b, the first radiator 111c, or the first radiator 111d. During specific disposition, a specific disposition position of the coupling stub 1113d may be properly adjusted according to an actual requirement. Details are not described herein.

It may be understood that, in another example, the base frame of each first radiator may alternatively be a polygonal, circular, elliptical, or another regular-shaped frame structure. During actual application, a specific structure type of the base frame may be properly selected and set. Details are not described herein.

As shown in FIG. 8, in an example provided in this application, the feeding parts of the four first radiators are all disposed close to each other. The feeding part 1111a is located at a corner of a base frame 1112a, the feeding part 1111b is located at a corner of a base frame 1112b, the feeding part 1111c is located at a corner of a base frame 1112c, and the feeding part 1111d is located at a corner of a base frame 1112d. The feeding part 1111a, the feeding part 1111b, the feeding part 1111c, and the feeding part 1111d are all located near a center of the radiation assembly 11. The foregoing structure disposition can effectively improve convenience of implementing a feeding connection between the radiation assembly 11 and the coupling structure 12, and can effectively reduce a size of the coupling structure 12.

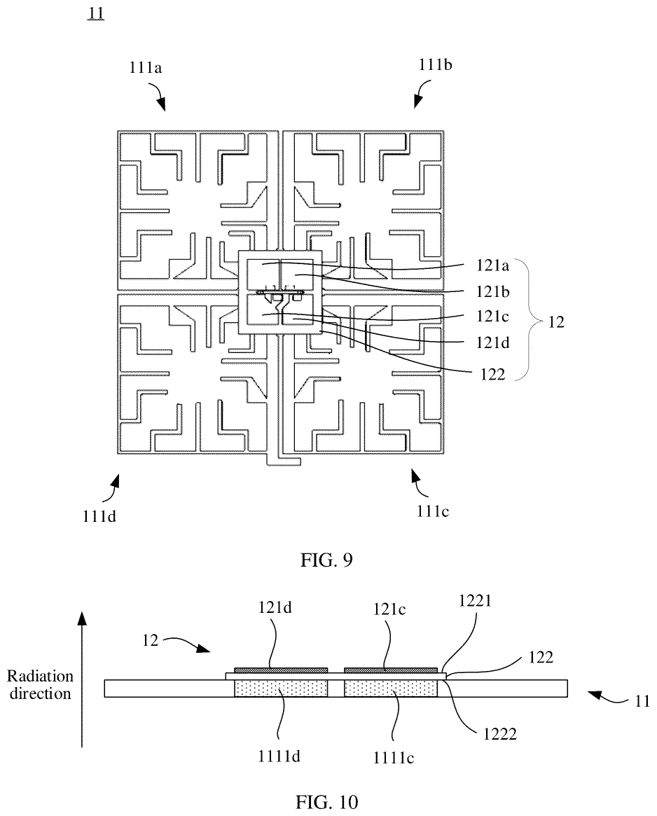

As shown in FIG. 9 and FIG. 10, in an example provided in this application, the coupling structure 12 includes a first substrate 122, and the first substrate 122 has a first plate surface 1221 and a second plate surface 1222 that are disposed opposite to each other. The first plate surface 1221 has a plurality of conductive plates, and each conductive plate forms the coupling part.

Specifically, shapes of the coupling part 121a, the coupling part 121b, the coupling part 121c, and the coupling part 121d of the coupling structure 12 are all rectangular. During actual application, shapes and sizes of the coupling part 121c and the feeding part 1111c are basically the same, and projections of the coupling part 121c and the feeding part 1111c basically overlap; and shapes and sizes of the coupling part 121d and the feeding part 1111d are basically the same, and projections of the coupling part 121d and the feeding part 1111d basically overlap. The foregoing structure disposition can effectively ensure an area of coupling between the coupling part 121c and the feeding part 1111c, and can effectively reduce areas of the coupling part 121c and the feeding part 1111c, thereby helping implement miniaturization of the coupling structure 12. Certainly, the shapes of the coupling part 121a, the coupling part 121b, the coupling part 121c, and the coupling part 121d are basically the same, and structures of the feeding part 1111a, the feeding part 1111b, the feeding part 1111c, and the feeding part 1111d are basically the same. Details are not described herein.

The first substrate 122 may be a substrate for preparing a printed circuit board, or may be a substrate for preparing a flexible circuit board. During actual application, a specific type of the first substrate 122 may be properly selected according to an actual requirement. This is not limited in this application. In addition, the conductive plate forming the coupling part may be a metal plate disposed on the first substrate 122, or may be a metal coating directly formed on the first substrate 122. During actual application, a specific structure and disposition manner of the coupling part may be properly selected and adjusted according to an actual requirement. This is not limited in this application.

During actual application, the feeding part may be specifically disposed at various positions.

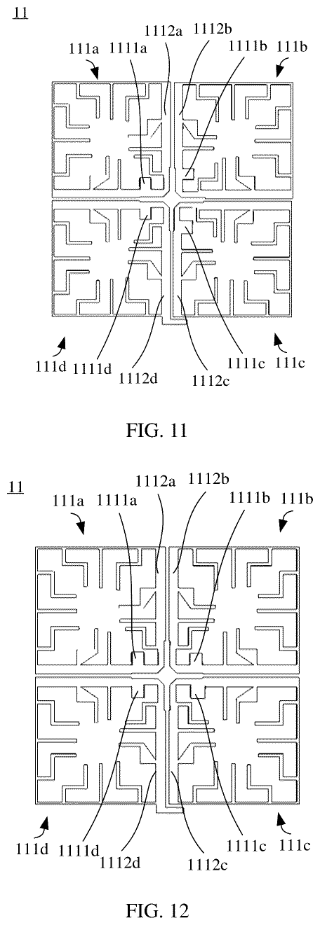

For example, as shown in FIG. 11, in an example provided in this application, the feeding part 1111a is located at a non-corner of a base frame 1112a, the feeding part 1111b is located at a non-corner of a base frame 1112b, the feeding part 1111c is located at a non-corner of a base frame 1112c, and the feeding part 1111d is located at a non-corner of a base frame 1112d.

Specifically, as shown in FIG. 11, the feeding part 1111a and the feeding part 1111d are disposed relatively close to each other, and the feeding part 1111b and the feeding part 1111c are disposed relatively far away from each other.

Alternatively, as shown in FIG. 12, the feeding part 1111a and the feeding part 1111d are disposed relatively close to each other, and the feeding part 1111b and the feeding part 1111c are disposed relatively close to each other. In addition, the feeding part 1111a and the feeding part 1111b are disposed relatively far away from each other, and the feeding part 1111c and the feeding part 1111d are disposed relatively far away from each other.

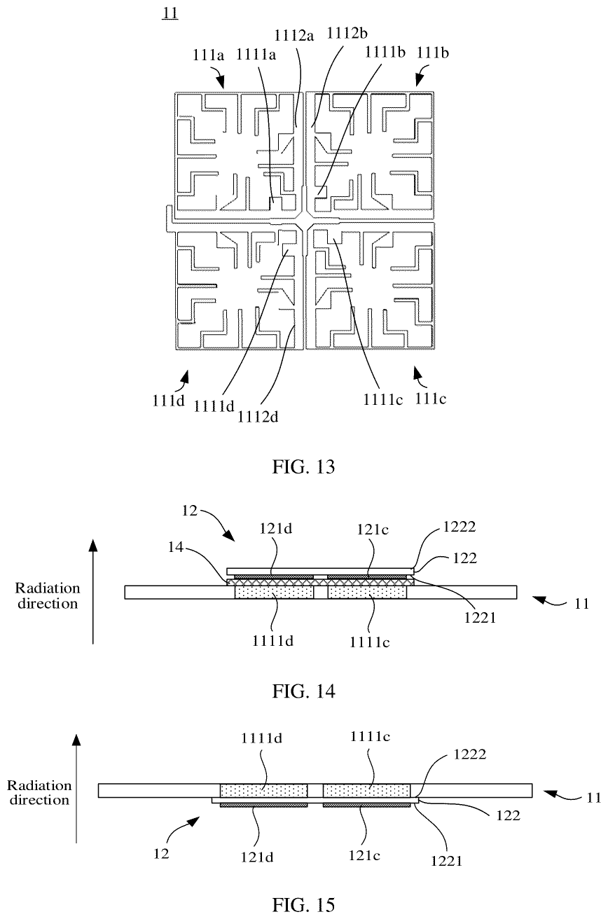

Alternatively, as shown in FIG. 13, the feeding part 1111a and the feeding part 1111b are disposed relatively far away from each other, the feeding part 1111b and the feeding part 1111c are disposed relatively far away from each other, the feeding part 1111c and the feeding part 1111d are disposed relatively far away from each other, and the feeding part 1111d and the feeding part 1111a are disposed relatively far away from each other.

In summary, during actual application, a specific disposition position of each feeding part 1111 may be flexibly set and adjusted according to an actual requirement. In addition, a relative position relationship between adjacent feeding parts 1111 may also be flexibly set and adjusted according to an actual requirement. Details are not described herein.

In addition, when the coupling structure 12 is specifically disposed, specific position layouts of the coupling part 121a, the coupling part 121b, the coupling part 121c, and the coupling part 121d in the coupling structure 12 may also be correspondingly set based on position layouts of the feeding part 1111a, the feeding part 1111b, the feeding part 1111c, and the feeding part 1111d. Details are not described herein.

In addition, during specific disposition, there may also be various relative disposition relationships between the radiation assembly 11 and the coupling structure 12.

For example, as shown in FIG. 9 and FIG. 10, in an example provided in this application, the coupling structure 12 is located in a radiation direction of the radiation assembly 11. The second plate surface 1222 is attached to the feeding part 1111d and the feeding part 1111c of the radiation assembly 11, and a thickness of the first substrate 122 is less than or equal to 1 mm. In other words, the radiation assembly 11 and the coupling part 121 are located on different sides of the first substrate 122. A spacing between the feeding part 1111d and the coupling part 121d that are correspondingly coupled may be ensured by using the thickness of the first substrate 122. A spacing between the feeding part 1111c and the coupling part 121c that are correspondingly coupled may be ensured by using the thickness of the first substrate 122.

In addition, a fixed connection may be further implemented between the coupling structure 12 and each first radiator in the radiation assembly 11 through the second plate surface 1222 of the first substrate 122, so that a relative position between different first radiators can be effectively ensured, and a fixed connection can also be implemented between the radiation assembly 11 and the coupling structure 12.

Alternatively, as shown in FIG. 14, in another example provided in this application, the coupling structure 12 is also located in a radiation direction of the radiation assembly 11, the antenna 10 further includes an insulating spacer 14, and a thickness of the insulating spacer 14 is less than or equal to 1 mm. The first plate surface 1221 of the coupling structure 12 is disposed facing the radiation assembly 11, and the insulating spacer 14 is attached between the radiation assembly 11 and the coupling structure 12. For example, the feeding part 1111d and the coupling part 121d that are correspondingly coupled may be effectively isolated by the insulating spacer 14, and a spacing between the feeding part 1111d and the coupling part 121d is ensured by using the thickness of the insulating spacer 14. The feeding part 1111c and the coupling part 121c that are correspondingly coupled may be effectively isolated by the insulating spacer 14, and a spacing between the feeding part 1111c and the coupling part 121c is ensured by using the thickness of the insulating spacer 14.

Alternatively, in another example, the coupling structure 12 may be located on a side that is of the radiation assembly 11 and that is away from a radiation surface.

For example, as shown in FIG. 15, in an example provided in this application, the second plate surface 1222 is attached to the feeding part 1111d and the feeding part 1111c of the radiation assembly 11, and a thickness of the first substrate 122 is less than or equal to 1 mm. In other words, the radiation assembly 11 and the coupling part 121 are located on different sides of the first substrate 122. A spacing between the feeding part 1111d and the coupling part 121d that are correspondingly coupled may be ensured by using the thickness of the first substrate 122. A spacing between the feeding part 1111c and the coupling part 121c that are correspondingly coupled may be ensured by using the thickness of the first substrate 122.

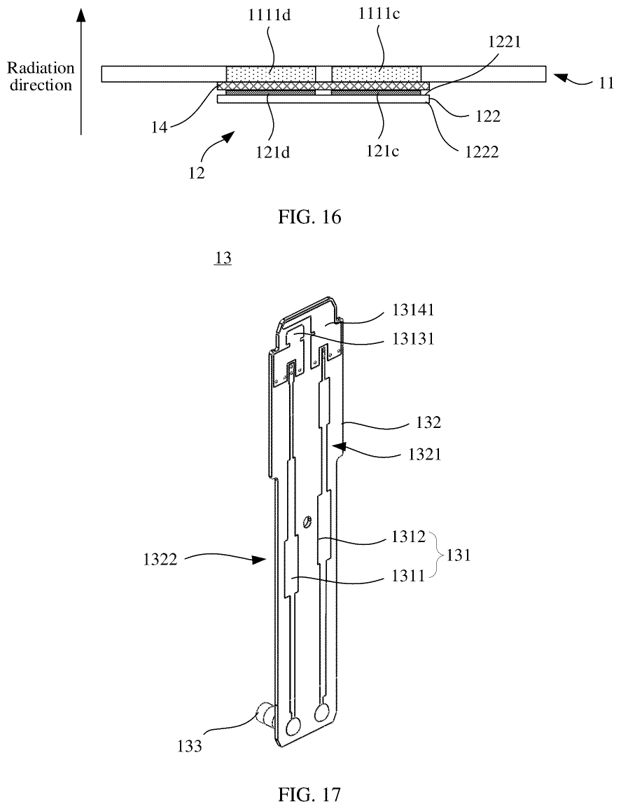

Alternatively, as shown in FIG. 16, in another example provided in this application, the first plate surface 1221 of the coupling structure 12 is disposed facing the radiation assembly 11, and the insulating spacer 14 is attached between the radiation assembly 11 and the coupling structure 12. In other words, the feeding part 1111d and the coupling part 121d that are correspondingly coupled may be effectively isolated by the insulating spacer 14, and a spacing between the feeding part 1111d and the coupling part 121d is ensured by using the thickness of the insulating spacer 14. A spacing between the feeding part 1111c and the coupling part 121c that are correspondingly coupled may be ensured by using the thickness of the first substrate 122.

During specific application, a relative position between the coupling structure 12 and the radiation assembly 11 may be properly set and adjusted according to different requirements. Details are not described herein.

In addition, during specific disposition, there may be various specific types of the balun structure 13.

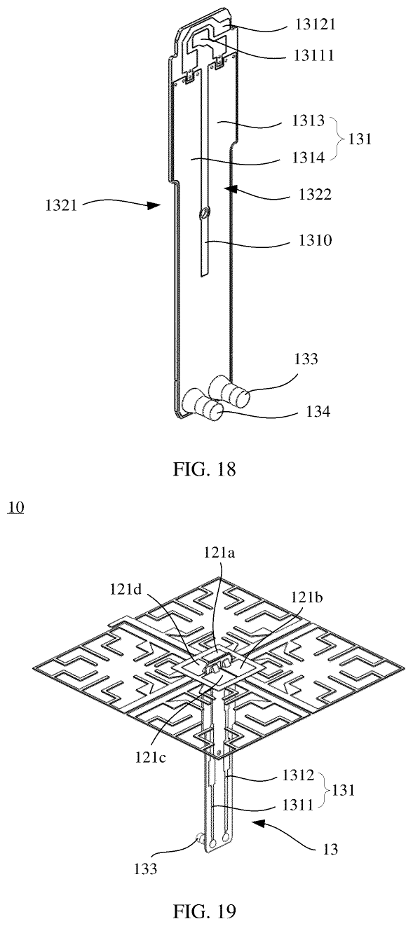

For example, as shown in FIG. 17 and FIG. 18, in an example provided in this application, the balun structure 13 includes a second substrate 132, and the second substrate 132 has a third plate surface 1321 and a fourth plate surface 1322 that are opposite to each other. The feed lines 131 specifically include a first polarization feed line 1311, a second polarization feed line 1312, a first polarization ground plate 1313, and a second polarization ground plate 1314. The first polarization feed line 1311 and the second polarization feed line 1312 are disposed on the third plate surface 1321, and the first polarization feed line 1311 and the second polarization feed line 1312 are parallel to each other. The first polarization ground plate 1313 and the second polarization ground plate 1314 are disposed on the fourth plate surface 1322, and there is a spacing 1310 between the first polarization ground plate 1313 and the second polarization ground plate 1314.

Refer to FIG. 17, FIG. 18, and FIG. 19. The first polarization feed line 1311 is welded to the coupling part 121a, the second polarization feed line 1312 is welded to the coupling part 121b, the first polarization ground plate 1313 is welded to the coupling part 121c, and the second polarization ground plate 1314 is welded to the coupling part 121d.

The first polarization feed line 1311 is located on the third plate surface 1321 of the second substrate 132, and one end 13111 of the first polarization feed line 1311 extends to the third plate surface 1321 via a through hole in the second substrate 132. The second polarization feed line 1312 is located on the third plate surface 1321 of the second substrate 132, and one end 13121 of the second polarization feed line 1312 extends to the third plate surface 1321 via a through hole in the second substrate 132. The first polarization ground plate 1313 is located on the fourth plate surface 1322 of the second substrate 132, and one end 13131 of the first polarization ground plate 1313 extends to the third plate surface 1321 via a through hole in the second substrate 132. The second polarization ground plate 1314 is located on the fourth plate surface 1322 of the second substrate 132, and one end 13141 of the second polarization ground plate 1314 extends to the third plate surface 1321 via a through hole in the second substrate 132.

In an example provided in this application, the balun structure 13 is a single-layer plate structure and has an advantage of flattening, so that manufacturing convenience and application flexibility of the balun structure 13 can be effectively improved.

During actual application, the second substrate 132 may be a substrate for preparing a printed circuit board, or may be a substrate for preparing a flexible circuit board. During actual application, a specific type of the second substrate 132 may be properly selected according to an actual requirement. This is not limited in this application. In addition, the first polarization feed line 1311 and the second polarization feed line 1312 may be specifically microstrips, strip lines, or the like. Specific types of the first polarization feed line 1311 and the second polarization feed line 1312 are not limited in this application.

In addition, as shown in FIG. 18, in an example provided in this application, there is a spacing 1310 between the first polarization ground plate 1313 and the second polarization ground plate 1314. A length of the spacing 1310 may be greater than or equal to 0.125λ and less than or equal to 0.25λ, a width of the spacing 1310 may be greater than or equal to 0.01λ and less than or equal to 0.1λ, and λ is a wavelength of an electromagnetic wave of a lowest operating frequency of the first radiator in the radiation assembly 11 when the electromagnetic wave is propagated in space. The spacing 1310 can effectively ensure isolation between the first polarization ground plate 1313 and the second polarization ground plate 1314, thereby ensuring isolation between first radiators in different polarization directions in the radiation assembly 11, and ensuring operating performance of the antenna 10.

In addition, as shown in FIG. 18, in an example provided in this application, the balun structure 13 further includes a first polarization interface 133 and a second polarization interface 134. Both the first polarization interface 133 and the second polarization interface 134 are coaxial cable interfaces. Both the first polarization feed line 1311 and the first polarization ground plate 1313 are connected to the first polarization interface 133, and both the second polarization feed line 1312 and the second polarization ground plate 1314 are connected to the second polarization interface 134. A connection between the balun structure 13 and a coaxial cable may be implemented through the first polarization interface 133 and the second polarization interface 134. It may be understood that the coaxial cable is an unbalanced transmission line, and the balun structure 13 can improve unbalanced feeding, thereby ensuring operating performance of the antenna 10.

In addition, during actual application, the antenna 10 may alternatively use a currently common balun structure 13. Details are not described herein again.

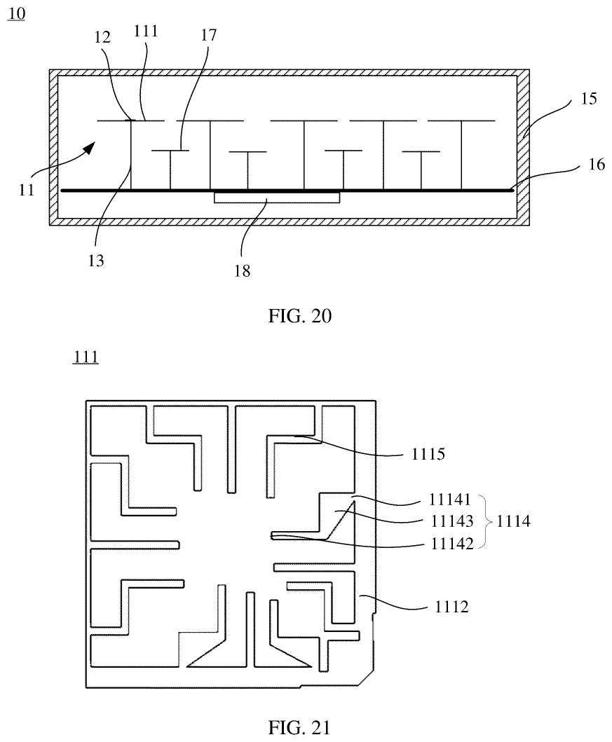

As shown in FIG. 20, when the antenna 10 is specifically disposed, the antenna 10 may include a plurality of radiation assemblies 11, and a first radiator 111 in each radiation assembly 11 is equipped with a corresponding coupling structure 12 and balun structure 13. In addition, the antenna 10 may further include a radome 15, and a reflection plate 16 and a feed network 18 that are located in the radome 15, and one end (for example, a lower end in FIG. 20) of the balun structure 13 passes through the reflection plate 16 and then is connected to the feed network 18.

In addition, as shown in FIG. 20, in an example provided in this application, the antenna 10 further includes a second radiator 17. The first radiator 111 is located in a radiation direction of the second radiator 17, and an operating frequency band of the second radiator 17 is greater than an operating frequency band of the first radiator 111. During actual application, the first radiator 111 and the second radiator 17 operate on different frequency bands, so that performance such as a bandwidth of the antenna 10 can be effectively extended.

In addition, as shown in FIG. 21, the first radiator 111 further includes a plurality of first open-circuit stubs 1114 (three first open-circuit stubs are shown in FIG. 21). The first open-circuit stub 1114 has a first end 11141 and a second end 11142, the first end 11141 is connected to the base frame 1112, the second end 11142 extends to the inside of the base frame 1112, and the first open-circuit stub 1114 has a gradient structure 11143 between the first end 11141 and the second end 11142. The gradient structure 11143 in the first open-circuit stub 1114 can effectively implement decoupling between the first radiator 111 and the second radiator 17, to avoid an adverse situation such as interference between the first radiator 111 and the second radiator 17, thereby ensuring operating performance of the antenna 10.

It may be understood that, during actual application, the second radiator 17 is also equipped with a corresponding balun structure. The second radiator 17 and the corresponding balun structure may use currently common types. Alternatively, the second radiator 17 may use a structure form similar to that of the first radiator 111, and the second radiator 17 may also be equipped with a coupling structure, a balun structure, and the like corresponding to the second radiator 17. Details are not described herein.

The gradient structure 11143 means that a cross-sectional shape of the gradient structure 11143 increases or decreases on a connection path between the first end 11141 and the second end 11142. During specific disposition, a shape of the gradient structure 11143 may be any one of a triangle, a diamond, an ellipse, or a semi-ellipse. A specific structure type and size of the gradient structure 11143 may be properly adjusted according to an actual requirement. Details are not described herein.

In addition, as shown in FIG. 21, in an example provided in this application, the first radiator 111 may further include a second open-circuit stub 1115, a length of the second open-circuit stub 1115 is ⅛λ′, and λ′ is a wavelength corresponding to a center frequency of the second radiator 17. The second open-circuit stub 1115 is disposed, so that decoupling between the first radiator 111 and the second radiator 17 can be effectively implemented, to avoid an adverse situation such as interference caused by the first radiator 111 to radiation performance of the second radiator 17, thereby ensuring operating performance of the antenna 10. The second open-circuit stub 1115 may be straight-line-shaped, broken-line-shaped, cross-shaped, or the like.

During specific disposition, a plurality of second open-circuit stubs 1115 may be disposed, and a distance between two adjacent second open-circuit stubs 1115 is less than or equal to 0.2λ′. During actual application, shapes, a quantity, and position dispositions of second open-circuit stubs 1115 may be properly set according to an actual requirement. Details are not described herein.

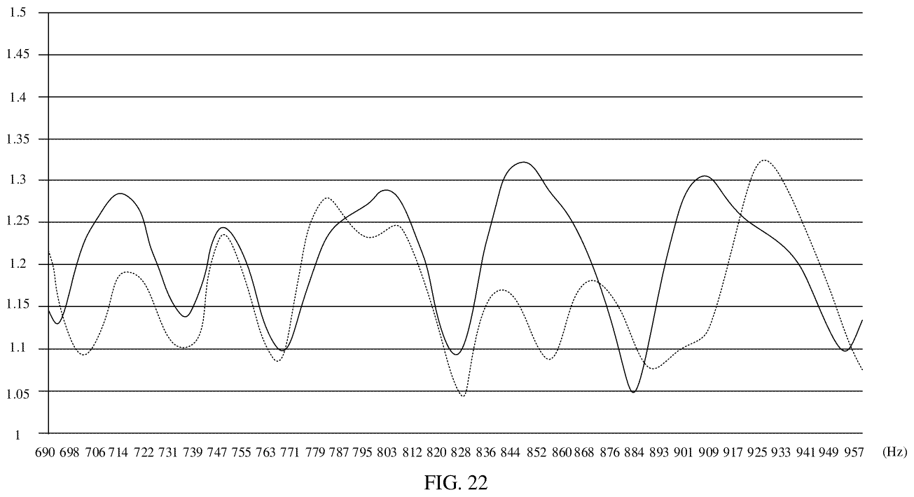

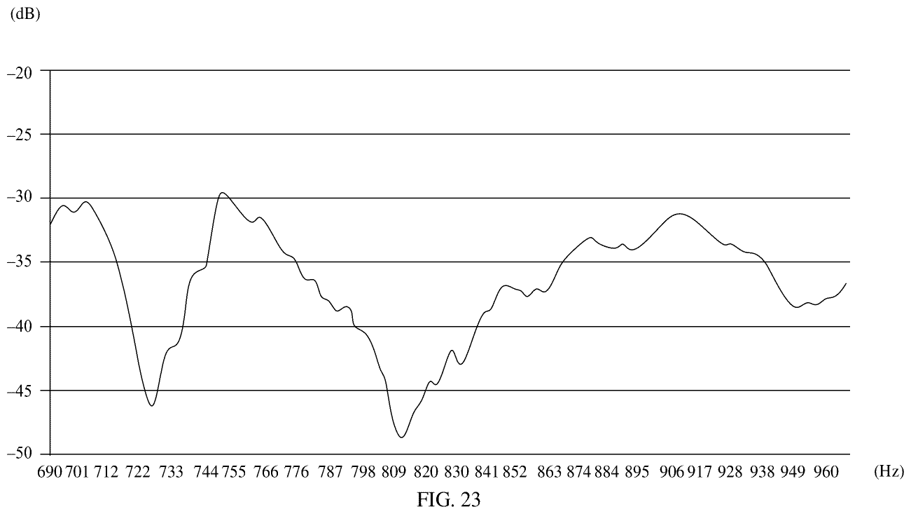

In addition, as shown in FIG. 22 and FIG. 23, an embodiment of this application further provides a data simulation diagram of an antenna 10.

FIG. 22 shows standing wave data of positive polarization and negative polarization of the antenna 10. A horizontal coordinate represents a frequency in a unit of GHz, and a vertical coordinate represents a standing wave ratio. A solid line represents a data simulation diagram of a frequency and a standing wave ratio of a positive polarized wave, and a dotted line represents a data simulation diagram of a frequency and a standing wave ratio of a negative polarized wave. It can be learned from the figure that a standing wave ratio of the antenna 10 may be less than 1.4, and has good standing wave performance.

FIG. 23 shows an isolation data diagram of the antenna 10. A horizontal coordinate represents a frequency in a unit of GHz, and a vertical coordinate represents isolation in a unit of dB. It can be learned from the figure that isolation of the antenna 10 may be greater than 30 dB, and has good radiation performance.

During actual application, the antenna 10 may be used in a plurality of different types of communication devices.

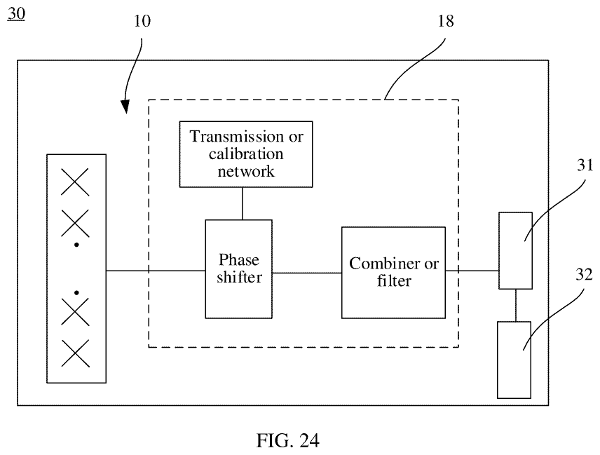

For example, as shown in FIG. 24, an embodiment of this application further provides a communication device 30, including any one of the foregoing antennas 10. The communication device may further include a radio frequency processing unit 31 and a baseband processing unit 32. The baseband processing unit 32 may be connected to a feed network 18 of the antenna 10 through the radio frequency processing unit 31. The radio frequency processing unit 31 may be configured to: perform frequency selection, amplification, and down-conversion processing on a signal received by the antenna 10, convert the signal into an intermediate frequency signal or a baseband signal, and send the intermediate frequency signal or the baseband signal to the baseband processing unit 32. Alternatively, the radio frequency processing unit 31 is configured to: perform up-conversion and amplification processing on an intermediate frequency signal sent by the baseband processing unit 32, convert the intermediate frequency signal into a radio signal through the antenna 10, and send the radio signal. During actual application, a specific type of the communication device 30 is not limited in this application. In addition, types and a quantity of components included in the communication device 30 may be properly selected and adjusted according to an actual requirement. Details are not described herein.

In embodiments of this application, unless otherwise stated or if there is a logic conflict, terms and/or descriptions in different embodiments are consistent and may be mutually referenced, and technical features in different embodiments may be combined into a new embodiment based on an internal logical relationship thereof.

In this application, “a plurality of” means two or more. In addition, “and/or” describes an association relationship between associated objects, and represents that three relationships may exist. For example, A and/or B may represent the following cases: Only A exists, both A and B exist, and only B exists, where A and B may be singular or plural.

It may be understood that various numbers in embodiments of this application are merely used for distinguishing for ease of description, and are not used to limit the scope of embodiments of this application. Sequence numbers of the foregoing processes do not mean an execution sequence, and the execution sequence of the processes should be determined based on functions and internal logic of the processes.

What is claimed is:

1. An antenna, comprising:
a radiation assembly, comprising a plurality of first radiators, wherein each first radiator has a feeding part;
a coupling structure, having a plurality of coupling parts, wherein the plurality of coupling parts are coupled to the plurality of feeding parts in one-to-one correspondence; and
a balun structure, having a plurality of feed lines, wherein the plurality of feed lines are connected to the plurality of coupling parts in one-to-one correspondence, wherein
in the coupling part and the feeding part that are correspondingly coupled, there is a spacing between the coupling part and the feeding part, an area of overlapping between the coupling part and the feeding part is greater than or equal to 0.025λ*0.025λ, and the spacing between the coupling part and the feeding part is less than or equal to 1 mm; and
λ is a wavelength of an electromagnetic wave of a lowest operating frequency of the first radiator when the electromagnetic wave is propagated in space.

2. The antenna according to claim 1, wherein the coupling structure comprises a first substrate, and the first substrate has a first plate surface and a second plate surface that are disposed opposite to each other; and
the first plate surface has a plurality of conductive plates, and each conductive plate forms the coupling part.

3. The antenna according to claim 2, wherein the second plate surface is attached to the feeding part, and a thickness of the first substrate is less than or equal to 1 mm.

4. The antenna according to claim 2, wherein the antenna further comprises an insulating spacer, and a thickness of the insulating spacer is less than or equal to 1 mm; and
the first plate surface is disposed facing the feeding part, and the insulating spacer is attached between the feeding part and the coupling part.

5. The antenna according to of claim 1, wherein the plurality of first radiators comprise a first polarization radiator and a second polarization radiator that are adjacently disposed;
the first polarization radiator has a coupling stub extending along an edge of the second polarization radiator, a spacing between the coupling stub and the second polarization radiator is less than or equal to 2 mm, and a length of the coupling stub is greater than or equal to 0.02λ and less than or equal to 0.1λ; and
λ is the wavelength of the electromagnetic wave of the lowest operating frequency of the radiator when the electromagnetic wave is propagated in space.

6. The antenna according to claim 5, wherein the balun structure comprises a second substrate;
the second substrate has a third plate surface and a fourth plate surface that are opposite to each other, and the third plate surface has a first polarization feed line and a second polarization feed line that are disposed in parallel;
the fourth plate surface has a first polarization ground plate and a second polarization ground plate, and there is a spacing between the first polarization ground plate and the second polarization ground plate; and a length of the spacing is greater than or equal to 0.125λ and less than or equal to 0.25λ, a width of the spacing is greater than or equal to 0.01λ and less than or equal to 0.1λ, and λ is the wavelength of the electromagnetic wave of the lowest operating frequency of the first radiator when the electromagnetic wave is propagated in space; and
the coupling structure has four coupling parts, and one end of the first polarization feed line, one end of the second polarization feed line, one end of the first polarization ground plate, and one end of the second polarization ground plate are respectively connected to the four coupling parts.

7. The antenna according to claim 1, wherein the antenna further comprises a second radiator, the first radiator is located in a radiation direction of the second radiator, and an operating frequency band of the second radiator is greater than an operating frequency band of the first radiator.

8. The antenna according to claim 7, wherein the first radiator comprises a base frame and a first open-circuit stub, the first open-circuit stub has a first end and a second end, the first end is connected to the base frame, the second end extends to the inside of the base frame, and the first open-circuit stub has a gradient structure between the first end and the second end.

9. The antenna according to claim 8, wherein a shape of the gradient structure is a triangle, a diamond, an ellipse, or a semi-ellipse.

10. The antenna according to claim 7, wherein the first radiator further comprises a second open-circuit stub, a length of the second open-circuit stub is ⅛λ′, and λ′ is a wavelength corresponding to a center frequency of the second radiator.

11. The antenna according to claim 10, wherein the first radiator comprises a plurality of second open-circuit stubs, and a distance between two adjacent second open-circuit stubs is less than or equal to 0.2λ′.

12. The antenna according to claim 10, wherein the second open-circuit stub is straight-line-shaped, broken-line-shaped, or cross-shaped.

13. A communication device, comprising a radio frequency processing unit and the antenna, wherein the radio frequency processing unit is connected to a feed network in the antenna;
wherein the antenna comprises a radiation assembly, comprising a plurality of first radiators, wherein each first radiator has a feeding part;
a coupling structure, having a plurality of coupling parts, wherein the plurality of coupling parts are coupled to the plurality of feeding parts in one-to-one correspondence; and
a balun structure, having a plurality of feed lines, wherein the plurality of feed lines are connected to the plurality of coupling parts in one-to-one correspondence, wherein
in the coupling part and the feeding part that are correspondingly coupled, there is a spacing between the coupling part and the feeding part, an area of overlapping between the coupling part and the feeding part is greater than or equal to 0.025λ*0.025λ, and the spacing between the coupling part and the feeding part is less than or equal to 1 mm; and
λ is a wavelength of an electromagnetic wave of a lowest operating frequency of the first radiator when the electromagnetic wave is propagated in space.

14. The communication device according to claim 13, wherein the coupling structure comprises a first substrate, and the first substrate has a first plate surface and a second plate surface that are disposed opposite to each other; and
the first plate surface has a plurality of conductive plates, and each conductive plate forms the coupling part.

15. The communication device according to claim 14, wherein the second plate surface is attached to the feeding part, and a thickness of the first substrate is less than or equal to 1 mm.

16. The communication device according to claim 14, wherein the antenna further comprises an insulating spacer, and a thickness of the insulating spacer is less than or equal to 1 mm; and
the first plate surface is disposed facing the feeding part, and the insulating spacer is attached between the feeding part and the coupling part.

17. The communication device according to of claim 13, wherein the plurality of first radiators comprise a first polarization radiator and a second polarization radiator that are adjacently disposed;
the first polarization radiator has a coupling stub extending along an edge of the second polarization radiator, a spacing between the coupling stub and the second polarization radiator is less than or equal to 2 mm, and a length of the coupling stub is greater than or equal to 0.02λ and less than or equal to 0.1λ; and
λ is the wavelength of the electromagnetic wave of the lowest operating frequency of the radiator when the electromagnetic wave is propagated in space.

18. The communication device according to claim 17, wherein the balun structure comprises a second substrate;
the second substrate has a third plate surface and a fourth plate surface that are opposite to each other, and the third plate surface has a first polarization feed line and a second polarization feed line that are disposed in parallel;
the fourth plate surface has a first polarization ground plate and a second polarization ground plate, and there is a spacing between the first polarization ground plate and the second polarization ground plate; and a length of the spacing is greater than or equal to 0.125λ and less than or equal to 0.25λ, a width of the spacing is greater than or equal to 0.01λ and less than or equal to 0.1λ, and λ is the wavelength of the electromagnetic wave of the lowest operating frequency of the first radiator when the electromagnetic wave is propagated in space; and
the coupling structure has four coupling parts, and one end of the first polarization feed line, one end of the second polarization feed line, one end of the first polarization ground plate, and one end of the second polarization ground plate are respectively connected to the four coupling parts.

19. The communication device according to claim 13, wherein the antenna further comprises a second radiator, the first radiator is located in a radiation direction of the second radiator, and an operating frequency band of the second radiator is greater than an operating frequency band of the first radiator.

20. The communication device according to claim 19, wherein the first radiator comprises a base frame and a first open-circuit stub, the first open-circuit stub has a first end and a second end, the first end is connected to the base frame, the second end extends to the inside of the base frame, and the first open-circuit stub has a gradient structure between the first end and the second end.
